(19) United States
(12) Patent Application Publication
(10) Pub. No.: US 2012/0290293 A1
(43) Pub. Date: Nov. 15, 2012

(54) Exploiting Query Click Logs for Domain Detection in Spoken Language Understanding

(75) Inventors: Dilek Hakkani-Tur, Fremont, CA (US); Larry Paul Heck, Los Altos, CA (US); Gokhan Tur, Fremont, CA (US)

(73) Assignee: Microsoft Corporation, Redmond, WA (US)

(21) Appl. No.: 13/234,202

(22) Filed: Sep. 16, 2011

Related U.S. Application Data
(60) Provisional application No. 61/485,664, filed on May 13, 2011.

(51) Int. Cl. G06F 17/27

(52) U.S. Cl. 704/9

(57) ABSTRACT

Domain detection training in a spoken language understanding system may be provided. Log data associated with a search engine, each associated with a search query, may be received. A domain label for each search query may be identified and the domain label and link data may be provided to a training set for a spoken language understanding model.

### RELATED APPLICATIONS

Under provisions of 35 U.S.C. §119(e), the Applicants claim the benefit of U.S. Provisional application No. 61/485,664, filed May 13, 2011, which is incorporated herein by reference.

Related U.S. patent application Ser. No. 13/234,186, filed on even date herewith entitled “Training Statistical Dialog Managers in Spoken Dialog Systems With Web Data,” assigned to the assignee of the present application, is hereby incorporated by reference.

### BACKGROUND

Search queries mined from search engine query logs may be analyzed to improve domain detection in spoken language understanding (SLU) applications. Three key tasks in understanding applications are domain classification, intent determination and slot filling. Domain classification is often completed first in SLU systems, serving as a top-level triage for subsequent processing. Domain detection systems may be framed as a classification problem. Given a user utterance or sentence xᵢ, a set yᵢ⊂ C of semantic domain labels may be associated with xᵢ, where C is the finite set of domains covered. To perform this classification task, the class with the maximum conditional probability, p(yᵢ|xᵢ) may be selected. In conventional systems, supervised classification methods may be used to estimate these conditional probabilities and each domain class may be trained from a set of labeled utterances. Collecting and annotating naturally spoken utterances to train these domain classes is often costly, representing a significant barrier to deployment both in terms of effort and finances.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Domain detection training in a spoken language understanding system may be provided. Log data associated with a search engine, each associated with a search query, may be received. A domain label for each search query may be identified and the domain label and link data may be provided to a training set for a spoken language understanding model.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing domain detection training;

FIG. 3 is a flow chart of a subroutine of the method of FIG. 2 for classifying domain labels; and

FIG. 4 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Embodiments of the present invention may provide for a system and/or method for exploiting query click logs in domain detection of spoken language utterances. The abundance of implicitly labeled web search queries in search engines may be leveraged to aid in training domain detection classes. Large-scale engines such as Bing® or Google® log more then 100M search queries per day. Each query in the log may be associated with a set of Uniform Resource Locators (URLs) that were clicked after the users entered the query. This user click information may be used to infer domain class labels and, therefore, may provide (potentially noisy) supervision in training domain classifiers. For example, the queries of two users who click on the same URL (e.g., http://www.hotels.com) are probably from the same domain (e.g., “hotels”).

A clicked URL category may be assigned as the domain label of a user query. For example, the label “hotels” may be assigned to the user query “Holiday Inn and Suites” when the user has clicked on http://www.hotels.com. However, click data may be noisy and occur with low frequency. Thus, it may also be useful to estimate successful clicks by mining query click logs to gather the set of URLs the people who searched by using the same exact query. Several features, such as query entropy, dwell times and session length may be evaluated for mining high-quality clicks. User action patterns and dwell time may be used to estimate successful search sessions. Query entropy and frequency may be integrated with other features from domain detection, such as the probabilities assigned by a domain detection model trained on labeled data, to sample high quality clicks both for adding as examples to the training set, and to pre-sample the data for use in supervised classifier training, and/or semi- and lightly-supervised learning methods such as label propagation.

A label propagation algorithm may transfer domain annotations from labeled natural language (NL) utterances to unlabeled web search queries. Click information may also be considered as noisy supervision, and the domain label extracted from the clicked URL category may be incorporated into the label propagation algorithm.

Query click data may include logs of search engine users' queries and the links they click from a list of sites returned by the search engine. Some click data, however, is very noisy, and may include links that were clicked on almost randomly. A sampling measure may be applied queries and domain labels from the clicked URLs for use in domain detection. Supervision from the noisy user clicks may then be included into the label propagation algorithm that may transfer domain labels from labeled examples to the sampled search queries.

A set of queries whose users clicked on the URLs that are related to target domain categories may be extracted. The query click logs may then be mined to download instances of these search queries and the set of links that were clicked on by search engine users who entered the same query. Criteria for sampling a subset of the queries may comprise query frequency, query (click) entropy, and/or query length. Query frequency may refer to the number of times a query has been searched by different users in a given time frame. In spoken dialog systems, users may ask the same things as web search users, hence adding frequent search queries to the domain detection training set may help to improve its accuracy. Query (click) entropy aims to measure the diversity of the URLs clicked on by the users of a query q, and may be computed according to Equation 1, below.

$$E ( q ) = - {\sum }_{i = 1}^{n} P ( {U}_{i} ) ln P ( {U}_{i} ) \qquad Equation 1$$

In Equation 1, Uᵢ, i=1 . . . n may comprise a set of URLs clicked by the users of query q and P(Uᵢ) may comprise the normalized frequency of the URL Uᵢ as computed according to Equation 2, below, where F(Ui) comprises the number of times the URL Uᵢ is clicked. Low click entropy may be a good indicator of the correctness of the domain category estimated from the query click label.

$$P ( {U}_{i} ) = \frac{F ( {U}_{i} )}{{\sum }_{i = 1}^{n} F ( {U}_{i} )} \qquad Equation 2$$

Query length may refer to the number of words in the query. The number of words in a query may comprise a good indicator of natural language utterances, and search queries that include natural language utterances instead of simply a sequence of keywords may be more useful for training data in SLU domain classification. The sampled queries may be added with the domain labels estimated from the clicked URLs to a labeled training set, or these sampled examples may be used for semi-supervised learning approaches such as self-training and/or label propagation. The label propagation algorithm may be extended to exploit the domain information from the clicked URLs.

Self-training may involve training an initial classifier from existing manually labeled examples. The initial classifier may be used to automatically assign labels for a larger set of unlabeled examples. Then the examples which were assigned classes with high posterior probabilities may be added to the training data.

Label propagation (LP) may comprise a graph-based, iterative algorithm commonly used for semi-supervised learning. The algorithm may propagate the labels through a dataset along high density areas defined by unlabeled examples in a manner similar to the k-Nearest-Neighbor (kNN) classification algorithm. LP may enable the classifier to see samples which have no common phrases to the training set. For example, if the training set has the phrase “hotel” but not “suites”, the example query above “holiday inn and suites” may propagate the label to another query, say “ocean-view suites”, which will propagate it to others. The LP algorithm converges and has a closed form solution for easier implementation.

Where {(xₗ, yₗ) . . . (xₗ, yₗ)} comprises a labeled data set, Y_{L}=yₗ, . . . , yₗ∈1, . . . , |C| for |C| classes. Let {(xₗ+1, yₗ+1) . . . (xₗ+u, yₗ+u)} be the unlabeled data set, where Y_{U}={yₗ+1, . . . , yₗ+u} is unknown. The samples X={xₗ+u} ∈ RD are from a D-dimensional feature space. The goal of label propagation may be to estimate Y_{U} from X and Y_{L}. As the first step, a fully connected graph may be created using the samples as nodes. The edges between the nodes, wᵢⱼ represent the Euclidean distance with a control parameter σ and may be computed according to Equation 3, below.

$${ω}_{ij} = exp ( - \frac{{d}_{ij}^{2}}{{σ}^{2}} ) = exp ( - \frac{{\sum }_{d = 1}^{D} {( {x}_{i}^{d} - {x}_{j}^{d} )}^{2}}{{σ}^{2}} ) \qquad Equation 3$$

With respect to Equation 3, xᵢ^{d} may comprise the value of the d^{th} feature of sample xᵢ. The graph may then be represented using a (l+u)×(l+u) probabilistic transition matrix T as computed according to Equation 4.

$${T}_{ij} = P ( j \to i ) = \frac{{ω}_{ij}}{{\sum }_{k = 1}^{l + u} {ω}_{kj}} \qquad Equation 4$$

A corresponding (l+u)×|C| matrix may also be defined for the labels. The labels for the unlabeled samples may initially be randomly set before iterating as follows. First, labels may be propagated 1 step (Y<−TY). Next, the rows of Y may be normalized to maintain a probability distribution before the labels of the labeled data are restored. This sequence converges to a fixed solution described below as Equation 5, where ( T̅) is the row normalized matrix of T, such that

$${\vec{T}}_{ij} = \frac{{T}_{ij}}{{\sum }_{k} {T}_{ik}}$$

and T̅ᵤₗ and T̅ᵤᵤ are the bottom left and right parts of T̅, obtained by splitting T̅ after the l^{th} row and column into four sub-matrices.

Y_{U}=(I− T̅ᵤᵤ)⁻¹ T̅ᵤₗY_{L} Equation 5

User-clicekd URLs may provide a noisy label for each query. The domain category assigned to each example by LP and the domain category of the clicked URL may therefore be checked for agreement, and those examples with high probability labels from LP, that also agree with the click label, may be added to a training data set.

A category of the clicked URL may also be used as a feature in the representation of a query. This may allow for propagation of labels between queries that have the same click labels with a higher weight in LP, thereby extending feature transformation approaches, such as the supervised latent Dirichlet allocation (sLDA) incorporating the correct labels and factored latent semantic analysis (fLSA) supporting the use of additional features.

|C| binary features may be included for each domain, resulting in a D+|C|-dimensional feature space. A value of 1 may be assigned to the feature corresponding to the click label of the query, and 0 to all the others. This may result in a straight-forward extension of the computation of the Euclidean distance with noisy supervision, as illustrated by Equation 6.

$${ω}_{ij} = exp ( - \frac{{\sum }_{d = 1}^{D + \vert C \vert} {( {x}_{i}^{d} - {x}_{j}^{d} )}^{2}}{{σ}^{2}} ) \qquad Equation 6$$

With respect to Equation 6, xᵢ^{D+k} may comprise a binary feature indicating a click of the URL for the k^{th} domain. The LP may be run and the top scoring examples for each domain may be added to the classification training data.

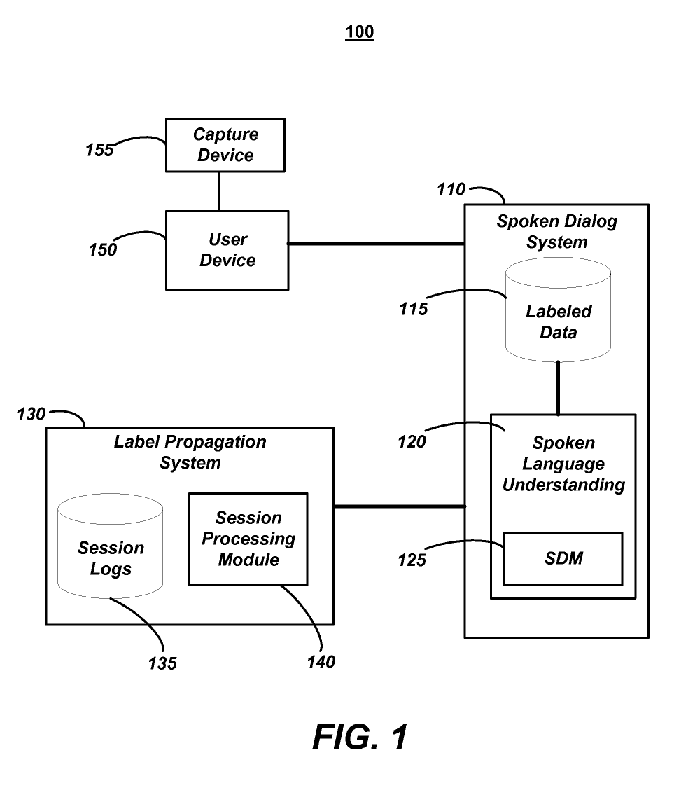

FIG. 1 is a block diagram of an operating environment 100 for providing a spoken dialog system (SDS) 110. SDS 110 may comprise a labeled data storage 115, a spoken language understanding component 120, and a statistical dialog manager 125. Labeled data 115 may be received from a label propagation system 130 comprising a plurality of session logs 135, such as may be associated with web search sessions, and a session processing module 140. Session processing module may be operative to analyze data from session logs 135 and provide training data comprising domain labels for various search queries to SDS 110. SDS 110 may be operative to interact with a user device 150, such as over a network (not shown). SDS 110 and label propagation system 130 may comprise separate servers in communication via a network and/or may comprise applications, processes, and/or services executing on shared hardware.

User device 150 may comprise an electronic communications device such as a computer, laptop, cell phone, tablet, game console and/or other device. User device 150 may be coupled to a capture device 155 that may be operative to record a user and capture spoken words, motions and/or gestures made by the user, such as with a camera and/or microphone. User device 150 may be further operative to capture other inputs from the user such as by a keyboard, touchscreen and/or mouse (not pictured). Consistent with embodiments of the invention, capture device 155 may comprise any speech and/or motion detection device capable of detecting the actions of the user. For example, capture device 155 may comprise a Microsoft® Kinect® motion capture device comprising a plurality of cameras and a plurality of microphones.

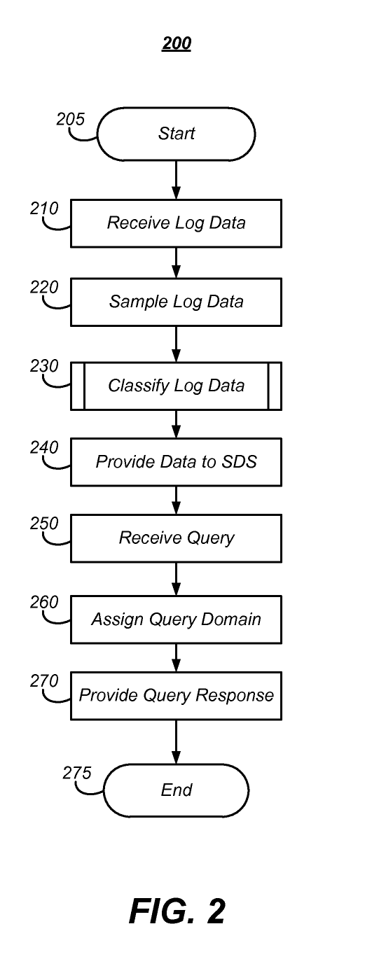

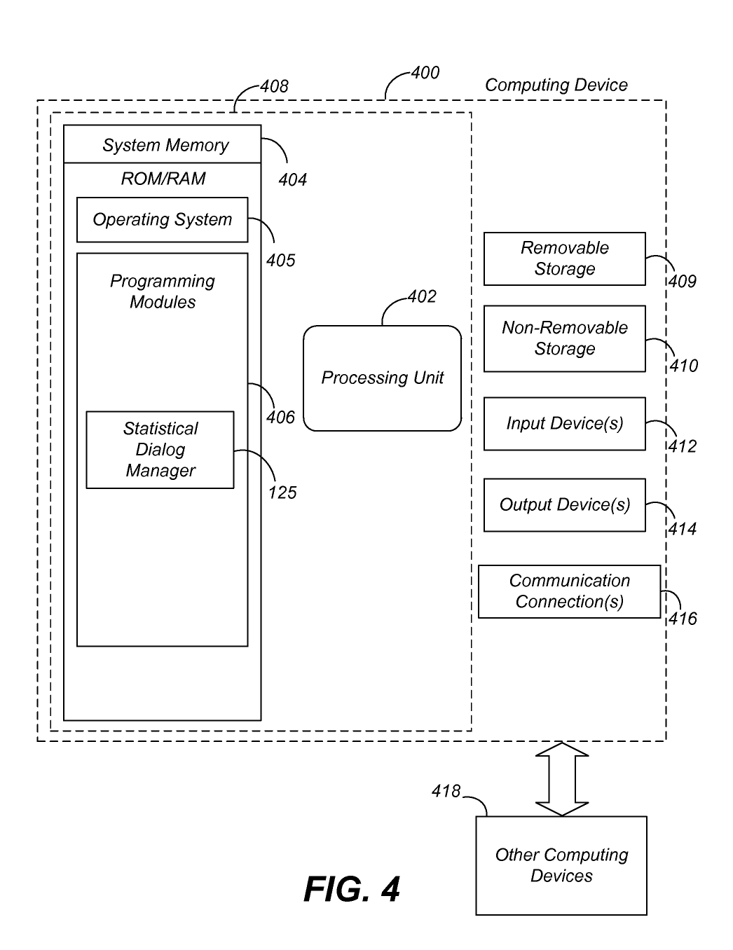

FIG. 2 is a flow chart setting forth the general stages involved in a method 200 consistent with an embodiment of the invention for providing statistical dialog manager training. Method 200 may be implemented using a computing device 400 as described in more detail below with respect to FIG. 4. Ways to implement the stages of method 200 will be described in greater detail below. Method 200 may begin at starting block 205 and proceed to stage 210 where computing device 400 may receive a plurality of query log data. For example, the query log data may comprise a search queries, followed links (e.g., uniform resource locators), non-followed links, and/or link characteristics, such as dwell time, associated with a web search session.

Method 200 may then advance to stage 220 where computing device 400 may sample a subset of the plurality of query log data according to one and/or more of the link characteristics. For example, label propagations system 130 may analyze link characteristics such as dwell time, query entropy, query frequency, and search query lengths to identify which of the log data comprises high correlations with a target domain.

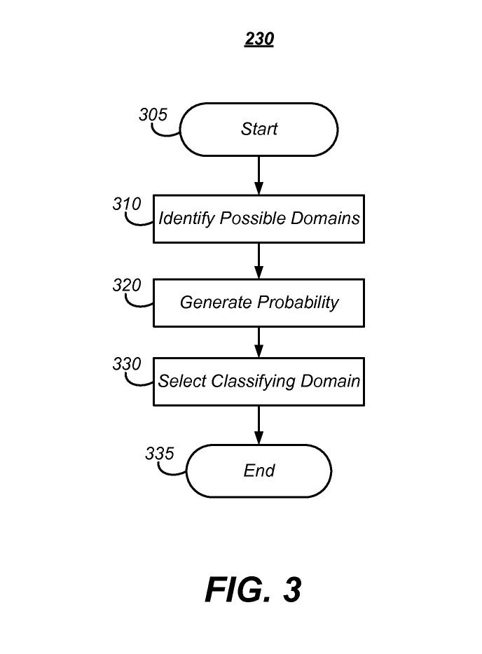

Method 200 may then advance to subroutine 230 where computing device 400 may classify each of the subset of the plurality of query log data into a domain label. For example, a session log comprising a search query of “hotels in Redmond” and a followed link to http://www.hotels.com may be classified in the “hotels” domain. The classification process is described below in greater detail with respect to FIG. 3.

Method 200 may then advance to stage 240 where computing device 400 may provide the subset of the plurality of query log data to a spoken language understanding model. For example, label propagation system 130 may provide the classified data to SDS 110 as training data and/or for use in responding to live queries.

Method 200 may then advance to stage 250 where computing device 400 may receive a natural language query from a user. For example, capture device 155 may record a user query of “I need a place to stay tonight,” and provide it, via user device 150, to SDS 110.

Method 200 may then advance to stage 260 where computing device 400 may assign a query domain to the natural language query according to the spoken language understanding model. For example, based on labeled log data received from label propagation system 130, the query may be mapped to prior web search queries of users looking for hotel rooms. Such prior queries may be classified in the “hotels” domain, and that data may result in SDM 125 assigning the received query into the same domain.

Method 200 may then advance to stage 270 where computing device 400 may provide a query response to the user according to the assigned query domain. For example, SDS 110 may perform a web search of hotels restricted by other information in the query (e.g., needs to have availability “tonight” and/or a presumption that the user is looking for a hotel nearby). Method 200 may then end at stage 275

FIG. 3 is a flow chart setting forth the general stages of subroutine 230 of method 200 consistent with an embodiment of the invention for classifying a domain label. Subroutine 230 may be implemented using computing device 400 as described in more detail below with respect to FIG. 4. Ways to implement the stages of subroutine 230 will be described in greater detail below. Subroutine 230 may begin at starting block 305 and proceed to stage 310 where computing device 400 may identify a plurality of possible domains associated with the link data. For example, session processing module 140 may select a group of target domains for which training data is sought and/or may select all possible domains associated with SDS 110.

Subroutine 230 may then advance to stage 320 where computing device 400 may generate a probability associated with each of the plurality of possible domains that the at least one of the plurality of link data is associated with the domain. For example, session processing module 140 may assign a probability that the search terms of the query are associated with each domain used by SLU 120.

Subroutine 230 may then advance to stage 330 where computing device 400 may select the classifying domain for the at least one of the plurality of possible link data from the plurality of possible domains. For example session processing module 140 may select the domain having the highest probability among the plurality of possible domains. Subroutine 230 may then end at stage 335 and return to method 200.

An embodiment consistent with the invention may comprise a system for providing domain detection training The system may comprise a memory storage and a processing unit coupled to the memory storage. The processing unit may be operative to receive a plurality of log data associated with a search engine, wherein each of the plurality of log data is associated with a search query, identify a domain label for the search query of at least one of the plurality of log data, and provide the domain label and the at least one of the plurality of link data to a training set for an understanding model.

Another embodiment consistent with the invention may comprise a system for providing domain detection training The system may comprise a memory storage and a processing unit coupled to the memory storage. The processing unit may be operative to identify a plurality of query log data associated with a target domain label, extract, from each of the plurality of query log data, a search query, at least one followed link, and at least one link characteristic, sample a subset of the plurality of query log data according to the at least one link characteristic, assign the target domain label to each of the subset of the plurality of query log data, and provide the subset of the plurality of query log data to a spoken language understanding model.

An embodiment consistent with the invention may comprise a system for providing domain detection training The system may comprise a memory storage and a processing unit coupled to the memory storage. The processing unit may be operative to receive a plurality of query log data, each comprising at least a search query, at least one followed link, and at least one link characteristic associated with a web search session, sample a subset of the plurality of query log data according to the at least one link characteristic associated with each of the subset of the plurality of query log data, classify each of the subset of the plurality of query log data into a domain label, and provide the subset of the plurality of query log data to a spoken language understanding model. The processing unit may be further operative to receive a natural language query from a user, assign a query domain to the natural language query according to the spoken language understanding model, and provide a query response to the user according to the assigned query domain.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise operating environment 400 as described above. Methods described in this specification may operate in other environments and are not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include SDM 125. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 404, including operating system 405. While executing on processing unit 402, programming modules 406 (e.g., statistical dialog manager 125) may perform processes and/or methods as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to providing training data for a spoken language understanding system may operate via application-specific logic integrated with other components of the computing device/system X on the single integrated circuit (chip).

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicants. The Applicants retain and reserve all rights in the code included herein, and grant permission to reproduce the material only in connection with reproduction of the granted patent and for no other purpose.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing domain detection training, the method comprising:
receiving a plurality of log data associated with a search engine, wherein each of the plurality of log data is associated with a search query;
identifying a domain label for the search query of at least one of the plurality of log data; and
providing the domain label and the at least one of the plurality of link data to a training set for an understanding model.

2. The method of claim 1, wherein each of the plurality of log data comprises at least one uniform resource locator (URL) selected from a plurality of search results associated with the search query.

3. The method of claim 2, wherein identifying the domain label comprises comparing the URLs associated with at least a subset of the plurality of log data.

4. The method of claim 3, wherein each of the subset of the plurality of log data is associated with the same search query.

5. The method of claim 4, wherein at least one of the plurality of log data not included in the subset of the plurality of log data is associated with a different search query.

6. The method of claim 1, further comprising:
determining whether the at least one of the plurality of link data comprises a successful search; and
in response to determining that the at least one of the plurality of link data does not comprise a successful search, discarding the at least one of the plurality of link data from the training set.

7. The method of claim 6, wherein determining whether the at least one of the plurality of link data comprises a successful search comprises analyzing at least one link characteristic associated with the at least one of the plurality of link data.

8. The method of claim 7, wherein the at least one link characteristic comprises at least one of the following: a dwell time, a query frequency, a query entropy, and a query length.

9. The method of claim 1, further comprising:
receiving a spoken query from a user; and
assigning a query domain to the spoken query according to the understanding model.

10. The method of claim 9, wherein assigning the query domain comprises calculating a probability that the spoken query correlates to the at least one domain label assigned to the search query of the at least one of the plurality of log data.

11. A system for providing domain detection training, the system comprising:
a memory storage; and
a processing unit coupled to the memory storage, wherein the processing unit is operable to:
identify a plurality of query log data associated with a target domain label,
extract, from each of the plurality of query log data, a search query, at least one followed link, and at least one link characteristic,
sample a subset of the plurality of query log data according to the at least one link characteristic,
assign the target domain label to each of the subset of the plurality of query log data, and
provide the subset of the plurality of query log data to a spoken language understanding model.

12. The system of claim 11, wherein the processing unit is further operative to identify the plurality of query log data for extraction according to a uniform resource locator (URL) known to be related to the target domain label.

13. The system of claim 11, wherein the subset of the plurality of query log data provided to the spoken language understanding model as a labeled training set.

14. The system of claim 11: wherein the subset of the plurality of query log data provided to the spoken language understanding model for use in a semi-supervised learning mode.

15. The system of claim 14, wherein the semi-supervised learning mode comprises a label propagation iterative algorithm.

16. The system of claim 14, wherein the semi-supervised learning mode comprises a self-training algorithm operative to assign domain labels to a second plurality of query log data according to the subset of the plurality of query log data.

17. The system of claim 11, wherein the at least one link characteristic comprises a query frequency associated with the at least one followed link.

18. The system of claim 11, wherein the at least one link characteristic comprises a query entropy measurement of a diversity of a plurality of URLs associated with the search query.

19. The system of claim 11, wherein the at least one link characteristic comprises a length of the search query.

20. A computer-readable medium which stores a set of instructions which when executed performs a method for providing domain detection training, the method executed by the set of instructions comprising:
receiving a plurality of query log data, wherein each of the query log data comprises a search query, at least one followed link, and at least one link characteristic associated with a web search session;
sampling a subset of the plurality of query log data according to the at least one link characteristic associated with each of the subset of the plurality of query log data, wherein the at least one link characteristic comprises at least one of the following: a dwell time, a query entropy, a query frequency, and a length of the search query,
classifying each of the subset of the plurality of query log data into a domain label, wherein classifying the at least one of the plurality of link data into the domain label comprises:
identifying a plurality of possible domains associated with the at least one of the plurality of link data, wherein the plurality of possible domains is selected from among all domains used by a spoken language understanding model,
generating a probability associated with each of the plurality of possible domains that the at least one of the plurality of link data is associated with the domain, and
selecting the classifying domain for the at least one of the plurality of possible link data from the plurality of possible domains according to the highest probability among the plurality of possible domains;
providing the subset of the plurality of query log data to a spoken language understanding model;
receiving a natural language query from a user;
assigning a query domain to the natural language query according to the spoken language understanding model; and
providing a query response to the user according to the assigned query domain.
